(19) United States
(12) Patent Application Publication
(10) Pub. No.: US 2015/0081591 A1
(43) Pub. Date: Mar. 19, 2015

(54) SYSTEM AND METHOD FOR COLLATERAL DATA AGGREGATION AND OPTIMIZATION

(71) Applicant: THE BANK OF NEW YORK MELLON, New York, NY (US)

(72) Inventors: Nadine S. CHAKAR, New York, NY (US); Kevin GAPP, Westfield, NJ (US)

(73) Assignee: THE BANK OF NEW YORK MELLON, New York, NY (US)

(21) Appl. No.: 14/030,437

(22) Filed: Sep. 18, 2013

(51) Int. Cl. G06Q 40/06

(52) U.S. Cl. CPC G06Q 40/06
USPC 705/36 R

(57) ABSTRACT

A system for managing collateral of a client of a financial services provider includes one or more processors configured to execute one or more computer program modules, configured to aggregate collateral data from a plurality of financial subsystems of the financial services provider as aggregated collateral data, the aggregated collateral data being associated with collateral across the plurality of financial subsystems. The program modules are also configured to calculate a cost associated with each of the collateral, across each of a plurality of categories described in the aggregated collateral data, calculate an optimized cost based on a proposed reallocation of the collateral, the optimized cost being associated with a utilized amount of reallocated collateral, and transmit, for viewing on an electronic display communicatively linked with the one or more processors, the optimized cost based on the proposed reallocation. Associated systems and methods are also disclosed.

### BACKGROUND

This application is directed to computer-implemented systems and methods useful for collateral management. While aspects of this application may be associated with various types of collateral allocations, the computerized systems and methods for allocating collateral described herein may be in reference to centralizing collateral management and aggregating collateral data across business units.

A financial service provider may provide to clients a variety of services which may be traditionally disparate in various regards. Each of the services may be associated with discrete business units for the financial service provider, and may be developed and managed generally independently from one another. Accordingly, where a client is interacting with particular ones of the business units, such as to provide instructions for collateral allocations as pertaining to associated financial services, the client may not have readily available access to information regarding the their assets and collateral allocations presently allocated in other services at other business units. Examples of such businesses may include, for example, securities lending (e.g., providing clients the ability to lend out assets to generate additional income on otherwise idle assets), collateral finance (e.g., providing for the lending of the financial service provider's balance sheet to clients), liquidity (e.g., providing clients access to money market funds and securities, potentially while safekeeping margin positions at the financial service provider), derivatives (e.g., derivative margin management), and collateral management (e.g., providing clients the means to lend cash via short term repurchase agreements).

Among other things, what is needed is a system and method for providing centralized collateral management services to investors and asset owners in an aggregated fashion across a plurality of business units, and allow for optimization of the collateral associated therewith.

### SUMMARY

Various embodiments of this disclosure may be used in conjunction with existing financial services platforms, for example the Bank of New York Mellon's Tri-Party repurchase agreement products (RepoEdge®) which allow clients to outsource the operational aspects of their collateralized transactions, and Derivatives Margin Management (DM Edge®), which helps clients manage credit risks associated with derivatives transactions by enabling them to accept, monitor and re-transfer collateral. These services, among others such as Repo Margin Management (RM Edge®), MarginDirect^{SM}, and Derivatives Collateral Net (DCN), may be delivered to clients through AccessEdge^{SM}, a real-time, web-based portal. Features of these programs may be found on one or more of U.S. Pat. Nos. 8,145,552, 8,315,939, and 8,478,679, and U.S. patent application Ser. Nos. 13/411,090, 13/656,430, and 13/913,126, each of which are incorporated herein by reference in their entireties.

The operator/manager of the system and method of this disclosure may act as a service provider to investors or asset owners who may be clients of the service provider. The operator/manager may therefore perform various functions via the system and method which may provide value-added services leading to greater information transparency for the investors or asset owners, and enhance usage of their collateral.

According to an embodiment, a system for managing collateral of a client of a financial services provider includes one or more processors configured to execute one or more computer program modules. The program modules are configured to aggregate collateral data from a plurality of financial subsystems of the financial services provider as aggregated collateral data, the aggregated collateral data being associated with collateral across the plurality of financial subsystems. The program modules are also configured to calculate a cost associated with each of the collateral, across each of a plurality of categories described in the aggregated collateral data. The program modules are additionally configured to calculate an optimized cost based on a proposed reallocation of the collateral, the optimized cost being associated with a utilized amount of reallocated collateral. The program modules are further configured to transmit, for viewing on an electronic display communicatively linked with the one or more processors, the optimized cost based on the proposed reallocation.

According to another embodiment, a computer implemented method for managing collateral of a client of a financial services provider, implemented in a computer system comprising one or more processors configured to execute one or more computer program modules, includes aggregating, via the one or more processors, collateral data from a plurality of financial subsystems of the financial services provider as aggregated collateral data, the aggregated collateral data being associated with collateral utilized across the plurality of financial subsystems. The method also includes calculating, with the one or more processors, a cost associated with each of the collateral, across each of a plurality of categories described in the aggregated collateral data. The method additionally includes calculating, with the one or more processors, an optimized cost based on a proposed reallocation of the collateral being associated with a utilized amount of reallocated collateral. The method further includes transmitting, for viewing on an electronic display communicatively linked with the one or more processors, the optimized cost based on the proposed reallocation.

The system and method of this disclosure provides various capabilities as discussed more fully in the detailed description below.

### BRIEF DISCUSSION OF THE DRAWINGS

FIG. 1 illustrates a schematic embodiment of system for aggregating and optimizing collateral at a financial services provider;

FIG. 2 illustrates an embodiment of a process for aggregating and optimizing collateral;

FIGS. 3A-3B, 4-6, 7A-7C, 8, and 9A-9B illustrate various exemplary views of a graphical user interface configured to facilitate aggregating and optimizing collateral at a financial services provider;

FIG. 10 illustrates an exemplary computer system configured to perform the functions of systems and methods described herein;

FIG. 11 illustrates another embodiment of a system configured to perform the functions of systems and methods described herein

FIGS. 12A-B illustrate an example of an optimization process for a plurality of obligations being satisfied by a plurality of asset types; and

FIGS. 13A-B show formulae utilized in performing the optimization illustrated in FIGS. 12A-B.

### DETAILED DESCRIPTION

In the discussion of various embodiments and aspects of the system and method of this disclosure, examples of a processor may include any one or more of, for instance, a personal computer, portable computer, personal digital assistant (PDA), workstation, or other processor-driven device, and examples of network may include, for example, a private network, the Internet, or other known network types, including both wired and wireless networks.

Those with skill in the art will appreciate that the inventive concept described herein may work with various system configurations. In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device, or a signal transmission medium), and may include a machine-readable transmission medium or a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions.

Described herein is an exemplary system which may be implemented through computer software running in a processor to aggregate and optimize collateral allocations. This description is not intended to be limiting, but is merely provided to describe ways of accomplishing the functions associated with acting as a financial service provider on behalf of an asset owner or investor.

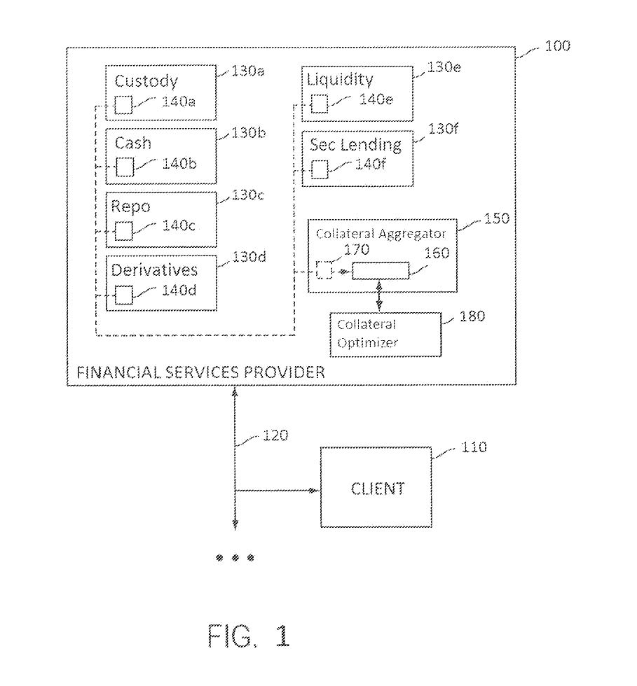

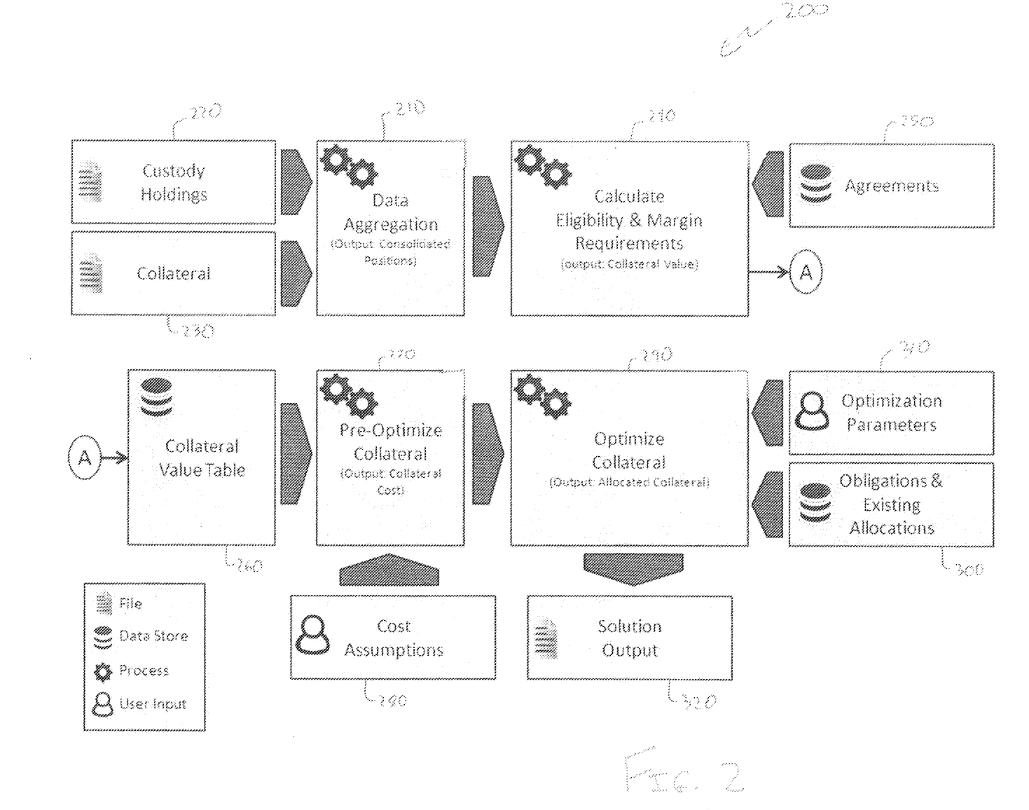

FIG. 1 schematically illustrates a networked relationship between a financial services provider 100 and a client 110. As shown, the client 110 is linked to the financial services provider 100 by a network 120, and it may be understood that the network 120 may be coupling computer systems or processors associated with each of the financial services provider 100 and the client 110. While the financial services provider 100 may have a plurality of clients 110 associated therewith (e.g., linked through the network 120), in the illustrated embodiment a single client 100 is shown for simplicity. In an embodiment, the financial services provider 100 may have various financial service subsystems 130 associated therewith. For example, as shown, in an embodiment the financial services provider 100 may have a custody subsystem 130a, a cash subsystem 130b, a repurchase agreement subsystem 130c, a derivatives subsystem 130d, a liquidity subsystem 130e, and a securities lending subsystem 130f. It may be appreciated that collateral 140 associated with the client 110 may be distributed throughout the subsystems 130. Accordingly, as illustrated, collateral 140a may be associated with the custody subsystem 130a, collateral 140b may be associated with the cash subsystem 130b, collateral 140c may be associated with the repurchase agreement subsystem 130c, collateral 140d may be associated with the derivatives subsystem 130d, collateral 140e may be associated with the liquidity subsystem 130e, and collateral 140f may be associated with the securities lending subsystem 130f.

As described herein, in an embodiment, the financial services provider 100 may provide an a collateral aggregation service to the client 110, wherein information regarding the collateral 140 associated with each of the subsystems 130 may be aggregated in a collateral data aggregator 150. Aggregated collateral information 160 may thereafter be provided to the client 110, so that the client 110 may ascertain the entirety of their holdings in the aggregate, which may facilitate an optimized reallocation of the collateral, as described in greater detail below. In an embodiment, the collateral data aggregator 150 may be configured to provide an interface to the client 110 to allow the client 110 to run queries to optimize the costs of funding their collateral activities. In an embodiment, the collateral data aggregator 150 may be configured to verify that the collateral 140 is not double counted when information thereof is being aggregated as the aggregated collateral information 160. In some embodiments, the aggregated collateral information 160 may comprise or be linked to information that traces the collateral 140 down to a security position level, and may facilitate data informatics and manipulation abilities for the client 110.

In an embodiment, the collateral data aggregator 150 may aggregate data associated with the collateral 140 into the aggregated collateral information 160 beyond the identity, amount, and usage of the collateral 140. For example, in various embodiments, the data aggregated into the aggregated collateral information 160 may include one or more of participant data, product data, and transaction date. For example, for a given security utilized as collateral, the data may include an identifier, such as the CUSIP, ISIN, or money market fund identifier. The data may also include position data (e.g., whether long or short), quantity, current price, or rating (e.g., from agencies such as Moodies, Fitch, or S&P). The data may also include the industry or sub industry associated with the collateral (e.g., consumer staple or technology). In an embodiment, the data may include the margin ability at various locations, the client legal entity the security resides in, or the genesis of the position (e.g., owned by the client 110 long or short, rehypothecated into the client 110, etc.). It may be appreciated that the location of the asset or collateral within the financial service provider 100 (e.g., the subsystem 130) may be included in the data. Other location information, such as whether it is outside of the financial service provider 100 (e.g., associated with a particular central clearing counterparty, sell side, or third party custodian) may additionally or alternatively be provided. In an embodiment, encumbrances on the collateral, such as deals it is associated with, what it is currently collateralizing, and how long it is obligated for (e.g., if it is securitizing a loan). In an embodiment, the security market cap value, the average 30 day trading volume (or other duration standard), the indices the asset is a member of (e.g., S&P 500, or Wilshire 3000), the issue currency, and/or the weighted average maturity may be provided with the data, aggregated into the aggregated collateral information 160. In various embodiments, start of day and/or intraday position data may be monitored.

In an embodiment, the collateral data aggregator 150 may be governed by policy data, which may be received from the client 110, may be pre-associated with the client 110 at the financial service provider 100, or may be ascertained from information such as that in data such as that aggregated into the aggregated collateral information 160. The policy data may include data pertaining to security (e.g., authorization, authentication and/or entitlements, such as that associated with data access). In an embodiment, the policy data may pertain to models being implemented at the collateral data aggregator 150 (e.g., constraints to the collateral data aggregator 150).

It may be appreciated that in various embodiments, the collateral data aggregator 150 may be configured to accept as inputs from the client 110, or from other systems or subsystems within the financial service provider 100, various inputs which may be utilized to ascertain collateral locations, or facilitate the optimization thereof. For example, in some embodiments, the collateral data aggregator 150 may recognize margin amounts, haircut amounts, or allowable collateral requirements for various counterparties, central clearing counterparties, and/or per asset class. In an embodiment, the collateral data aggregator 150 may recognize as an input funding cost assumptions by asset class and/or by product. In an embodiment, the collateral data aggregator 150 may be configured to optimize based on a variety of aggregation characteristics, including but not limited to price input or market view of an asset class, collateral limit by manager and/or by program, or a total buy-side portfolio return (by manager and portfolio).

In an embodiment, the collateral data aggregator 150 may be configured to selectively bind data into specific aggregated collateral data 160, facilitating specific views of the data in the aggregate. For example, in an embodiment, a data adapter 170 may be configured to engage with a graphical user interface accessible by the client 110 to guide the aggregation in a desired form. Other interfaces, such as text based interfaces, may be utilized in other embodiments. In an embodiment, a graphical user interface may be accessible by the financial service provider 100, for client service purposes, or for administration purposes. As described in greater detail below, the graphical user interface may be configured to display information such as the aggregated collateral information 160 (e.g., as selectively modified by the data adapter 170), to provide desired aggregate views to the client 110. In an embodiment, the graphical user interface displays may be generated for buy-side and/or sell-side types of clients 110, as well for internal users at the financial service provider 100. In an embodiment, views of custody long assets, including but not limited to encumbered assets (e.g., portions of long assets being used as collateral) and unencumbered assets (e.g., balances of long assets not being used as collateral) may be generated. In an embodiment, views of the collateral received, including but not limited to assets that may not be rehypothecated (e.g., portion of assets which the financial services provider 110 may be unable to use), rehypothecated assets (e.g., that being used), and available collateral (e.g., balance of collateral available for use) may be generated.

It may be appreciated that in various embodiments, the collateral data aggregator 150 may be configured to generate other views of collateral data for one or more of the client 110 and the financial services provider 100, including but not limited to the client legal entity, the legal entity of the financial services provider 100 (including a sub custody member thereof), the business unit of the financial services provider 100, the product (e.g., bilateral, tri-party, quad-party, central clearing counterparty/exchange). Displays of the country/region where the asset is located, the asset class (e.g., equity, fixed income, over-the-counter cleared or uncleared, money market, or exchange traded funds), asset industry, asset quality (e.g., large/small cap, rating, etc.), asset country of issue, counterparty, by cash, by security, or by liquidity (e.g., ranging from highly liquid to illiquid), may also be generated in various embodiments. In some embodiments, data such as one or more of current asset value, current collateral value, current funding cost, current use, current available/required, optimized minimum or maximum collateral value, optimized minimum or maximum funding cost, optimized minimum or maximum available or required, minimum or maximum buying power, and a change from collateral value to optimized value, such as that broken down by asset type, may additionally or alternatively be generated for display to the client 110 or the financial services provider 100.

In some embodiments, other data types, such as underlying trade activity (e.g., derivatives trade or pledge of assets for statutory deposit), may be provided, and may be utilized to maximize the value associated with the optimization, as described below. In an embodiment, some collateral may be segregated between clients 110 and their counterparties. In some such embodiments, to recommend how to use collateral, the financial service provider 100 may obtain access to the underlying transactions that generate the segregated nature of the collateral. In an embodiment, details regarding Credit Support Annexes, or other details for such transactions, may enable the financial services provider 100 to determine collateral eligibly, haircuts, or so on, and thus may additionally or alternatively be provided to the collateral data aggregator 150 (e.g., the data adapter 170 thereof).

Accordingly, it may be appreciated that the collateral data aggregator 150 may be configured to generally collect a variety of information regarding collateral 140 serviced by the financial services provider 100 and related information into a common location for the purpose of providing data in the aggregate to clients 110, who may be able to filter data based on a series of dimensions, in a manner which may facilitate the clients 110 obtaining a holistic view of their holdings and the usage thereof. In an embodiment, the collateral data aggregator 150 may be configured to provide a mechanism by which the clients 110 may send assets from outside of the financial service provider 100. The collateral data aggregator 150 may therefore be configured to present to clients 110 various characteristics of their holdings, such as reconciliation from total assets to available collateral, where the collateral is currently being used (e.g., by activity, product or legal agreement, asset class, client legal entity, or custody location), the largest counterparties by product and/or activity, the available collateral, and forecasting of collateral positions or availability (e.g., based on known future obligations and activities). With the aggregated view obtained through the collateral data aggregator 150, the client 110 may therefore not only obtain a consolidated view of all assets and collateral held at the financial services provider 100, but also the client 110 may utilize the collateral data aggregator 150 to subtotal assets and collateral by a variety of categories, identify how holdings relate to available collateral, recognize appreciable future collateral needs, categorize assets into customized liquidity and desirability groups, and/or identify contractually based counterparty exposures.

Once aggregated into the aggregated collateral data 160, the client 110, or the financial services provider 100, may optimize collateral allocations. In particular, a collateral optimizer 180 may have access to the aggregated collateral data 160, and may be configured to determine allocations of eligible assets in the portfolio of the client 110 to meet obligations using a variety of criteria, such as that provided by the client 110. For example, the algorithms and analytics associated with the collateral optimizer 180 may be configured to identify the best mix of assets (e.g., the collateral 140) to meet margin requirements associated with counterparties of the client 110. In an embodiment, the collateral optimizer 180 may assess the overcollateralization or undercollateralization of the portfolio of the client 110, utilizing criteria such as one or more of those defined by the client 110, standards defined by counterparties, asset allocation preferences, and concentration limits. Other factors may be considered in the collateral optimizer 180, including but not limited to an asset mix, a cost to fund margin, and a haircut requirement. In an embodiment, the collateral optimizer 180 may be configured to determine a preferred utilization of the assets as collateral 140 by running simulated scenarios, so as to determine whether the collateral 140 aggregated in the aggregated collateral data 160 is best utilized for financing, for collateral exchange, or for other assets needed as collateral. It may be appreciated that the collateral optimizer 180 may therefore be configured to allow the clients 110 to see the estimated cost (e.g., financial impact) of the collateral 140 as allocated, model various usage scenarios, and reallocate collateral to solve for a lowest estimated cost.

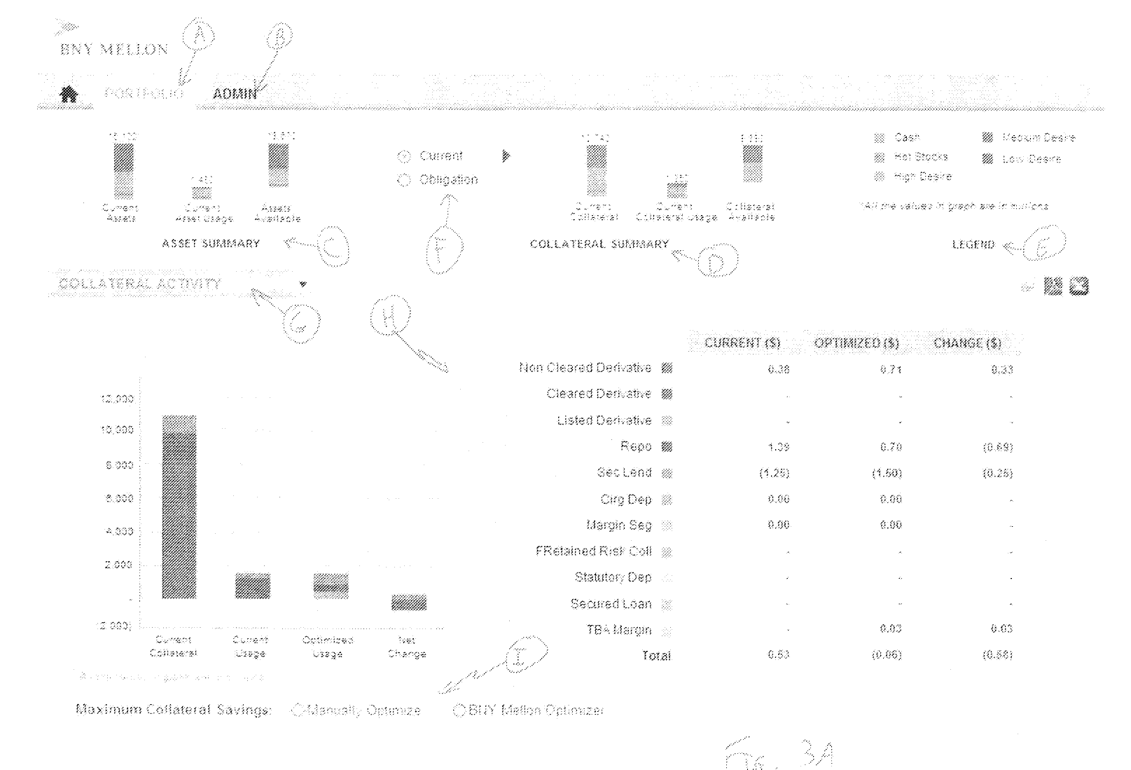

FIG. 2 illustrates an exemplary process 200 for collateral data aggregation and optimization. In an embodiment, the collateral data aggregation and optimization process 200 may be implemented on a system of the financial services provider 100, as described above, including but not limited to one or more of the collateral aggregator 150 and the collateral optimizer 180. As shown, in an embodiment process 200 may include at 210 data aggregation. In an embodiment, the data aggregation at 210 may include aggregation of custody holdings 220 and collateral 230. It may be appreciated that the custody holdings 220 and the collateral 230 may be similar to the collateral 140 and the associated data aggregated into the aggregated collateral data 160, as described above. In an embodiment, data aggregation at 210 may collect data such as the custody holdings 220 and the collateral 230 from a variety of sources, including sources both internal to and external from the financial services provider 100. In an embodiment, the assets a client 110 is capable of pleading to satisfy an obligation or generate revenue may be included in the data collected in the data aggregation at 210. In an embodiment this may include assets already pledged, rehypothecatable collateral or collateral received that can be reused to satisfy an obligation or generate revenue, and/or collateral already rehypothecated may be included in the data aggregated at 210. In an embodiment, the data aggregation at 210 may put the information into one or more multi-dimensional data stores. The data aggregation at 210 may thereafter output consolidated positions, which may be utilized to calculated eligibility and margin requirements at 240. In an embodiment, the margin calculation at 240 may take in the consolidated positions from the data aggregation at 210, and factor in existing agreement details 250 associated with each collateral destination. In an embodiment, the details 250 may include eligibility, haircut, and concentration limits which may be adhered to for each of the potential agreements. In an embodiment, the computation of margin requirements at 240 may output collateral values in a collateral value table 260. In an embodiment, each consolidated position may be margined for each potential agreement type, so that the collateral value table may comprise a set of hypothetical collateral values.

In some embodiments, process 200 may then continue at 270 by performing a pre-optimization process for the collateral. Such pre-optimization process at 270 may include calculating the cost of each consolidated collateral value from the collateral value table 260. The pre-optimization process at 270 may also factor in security type cost assumptions 280, which may be provided by the client 110, or may be obtained or computed from other sources. In an embodiment, the pre-optimization process at 270 may generate a cost for each consolidated collateral value, for each potential agreement type (e.g., collateral destination). In an embodiment, the pre-optimization process at 270 may calculate a collateral cost for each of a plurality of possible agreement types.

Process 200 may continue at 290 by optimizing the collateral allocations. Specifically, in some embodiments optimizing the collateral allocations at 290 may receive the collateral costs from the pre-optimization at 270, and factor in current obligations and existing allocations 300. Optimization parameters 310, including client driven optimization rules and constraints (e.g., user input), may be considered in the optimization at 290 as well. In some embodiments, the optimization parameters 310 may be received from the client 110, or may be provided by or otherwise computed by the financial services provider 100. In an embodiment, the optimization of collateral allocations at 290 may generate a solution 320, which may include an optimized allocation of collateral to each obligation. In an embodiment, the solution 320 may include a proposed allocation of assets and collateral to revenue generating trades. It may be appreciated that in some embodiments, the optimization at 290 may consider the existing allocation of collateral, and may provide instructions on how to affect the suggested optimization state. In an embodiment, the instructions may comprise reallocation instructions, which may be selectively implemented by financial services provider 100 (e.g., upon approval by the client 110).

While the optimization at 290 may vary across embodiments, as described in greater detail below in an embodiment the optimization at 290 may establish a basis point cost for each asset/security type to the security holdings of the client 110. The basis point cost may be received from or edited by the client 110 and may be at least initially suggested by the financial services provider 100. In an embodiment, the optimization at 290 may identify collateral requirements of the client and may selects the lowest cost security holding available to meet the collateral requirement, taking into account concentration limits, eligibility and haircuts as identified in the pre-optimization at 270. In an embodiment, the optimization parameters 310 may also be considered, as described herein. In some embodiments, once the lowest cost collateral is exhausted, the next lowest cost collateral security type is then used to fulfill the remaining collateral requirements. The optimization at 290 may continue until all requirements are fulfilled. In some embodiments, certain stocks or other revenue generating securities may be identified as potential incremental revenue, and thus may be prevented from being utilized as collateral (and instead would be utilized as potential revenue for securities lending).

In an embodiment, the optimization at 290 may be configured to minimize the amount of collateral required to fulfill obligations, and to determine what assets to encumber or what venues to source or transform collateral to meet the obligations such that cost (e.g., financial and opportunity costs) and risk may be minimized while yield may be maximized. While optimization at 290 may include a number of considerations therein, it may be appreciated that the constraints or minimizations described herein may be implemented either alone or together.

It may be appreciated that the optimization at 290 may be described utilizing a number of conventions, applicable in some embodiments. For example, in some embodiments, assets refer to securities (e.g., financial instruments) and cash in eligible currencies. In some embodiments, asset and collateral may be utilized interchangeably, since assets may be potential collateral. It may be appreciated that collateral optimization may be in the context of a particular market participant. As used herein, in an embodiment, [symbol] may represent the set of assets owned by the market participant. In an embodiment, [symbol] may represent the set of trades that the market participant is involved in. Trades may refer to an exchange of assets, such as in the case of financial trading and security financing trading, and obligation (with or without asset exchange), such as in the case of an insurer fulfilling statutory deposit requirements. It may be appreciated that as represented in the process 200 (e.g., as aggregated during the data aggregation 210), the assets may include attributes such as (but not limited to) one or more of a security identifier, type of security, market price, range of par sizes for security movement in the market place, and available positions. For trades, the attributes may include one or more of counterparty, collateral-in (to be received, e.g., for collateral financing trades), collateral-out (to be delivered), required value of collaterals, and the venue the trade is executed, for example. For a combination of collateral and trade, in some embodiments the attributes may include one or more of eligibility, margin or haircut, and correlation.

In an embodiment, the function b^{(a)}: [symbol] → [symbol] ^{(a)} may represent a function which maps an element xε [symbol] to the value of its attribute a, where [symbol] may be one above defined sets (e.g., [symbol] or [symbol] ), or their direct products, and [symbol] ^{(a)} may be a value domain of attribute a. As used herein, πₖ may represent the par value of collateral k. In an embodiment, ξₖ may represent the desirability of collateral k, and may be defined in the range [0, 10] with 0 being least desirable and 10 being most desirable. In some embodiments, N̅ₖ may represent the par amount of collateral k owned by the participant. In an embodiment, the value N_{d,k}⁽ⁱⁿ⁾ may represent the par amount of collateral k to be received by the participant for a trade d. In some embodiments, asset sourcing or transformation may be implemented in the optimization at 290, which may modify usage of the value N_{d,k}⁽ⁱⁿ⁾. In an embodiment, N_{d,k}^{(out)} may represent the par amount of collateral k to be delivered by the participant for the trade d.

In some embodiment, collateral-in and collateral-out eligibility matrices for a trade d and an asset k may respectively be represented by E_{d,k}⁽ⁱⁿ⁾ and E_{d,k}^{(out)}, such that

$$\{ \begin{matrix}1 & if k is eligible for trade d \\ 0 & otherwise\end{matrix} ,$$

where ζ=in or out indicating the direction of asset movement from the perspective of the participant. In an embodiment, N_{d,k}^{(ζ)}>0 only when E_{d,k}^{(ζ)}=1. Generally, E_{d,k}^{(ζ)} is a function of the attributes of d and k, but in some embodiments the function may be defined as a rule that takes values of the attributes as inputs to produce an outcome of 0 or 1.

In an embodiment, A_{d} may represent a haircut adjusted value of collaterals allocated to a trade d. Accordingly, as an example, A_{d} may be equal to

$${\sum }_{k ∈ 𝕂}^{ } {}^{( hav )} ( k ) \cdot {N}_{d , k}^{( out )} ,$$

where [symbol] ^{(hav)}(k)=πₖ·(1−h_{d,k}^{(out)}) may be understood as the haircut adjusted par value of collateral k, πₖ may be the unit price of the collateral, and h_{d,k}^{(out)} may be the haircut for the pair (d, k) when collateral is allocated to support a trade. In an embodiment, margin and haircut may be used interchangeably as described herein, as the margin M_{d,k}^{(ζ)}=h_{d,k}^{(ζ)}/(h_{d,k}^{(ζ)}). As per further conventions used herein, V_{d} may represent the value of required collaterals for a trade d, and the step function θ(x) may be utilized, where θ

$$( x ) = \{ \begin{matrix}1 & if x > 0 \\ 0 & if x \leq 0\end{matrix} .$$

It may be appreciated that a number of constraints may be implemented in the optimization at 290. For example, in an embodiment, the allocated par amount may be constrained as a non-negative integer. In an embodiment, the allocated par amount, if allocated, may be constrained to be within a range of par sizes valid for security movement in the market. For example, N_{d,k}^{(ζ)}ε{0}∪[N_{d,k}^{(min)},N_{d,k}^{(max)}]. In an embodiment, the allocated par amount may be constrained to not be greater than what is owned. For example,

$${\sum }_{d ∈ 𝔻} {N}_{d , k}^{( out )} \leq {\overline{N}}_{k} for all k ∈ 𝕂 .$$

In some embodiments, a general concentration limit constraint may be applied, such that

$${\sum }_{d ∈ 𝔻} {\sum }_{k ∈ 𝕂}^{ } {C}_{d , k}^{( ℛ )} \leq {\overline{C}}^{( ℛ )} ,$$

where [symbol] is the concentration limit associated with a concentration rule [symbol] , and C_{d,k}⁽ [symbol] ⁾ is a concentration function. In some embodiments, the concentration rule [symbol] may be defined by the pledged-to counterparty of a trade. It may be appreciated that in some embodiments, differing definitions of the concentration rule [symbol] may give rise to different categories of concentration limits, while the same [symbol] may give rise to instances of concentration limits in the same category. It may be appreciated that C_{d,k}⁽ [symbol] ⁾ may be a function of the rule [symbol] and the attributes of d and k, and may be written as C_{d,k}⁽ [symbol] ⁾=_{d,k}^{(ζ,} [symbol] ⁾·N_{d,k}^{(ζ)}·V_{d,k}^{(ζ,} [symbol] ⁾. As so written, the indicator function I_{d,k}^{(ζ,} [symbol] ⁾ may determine whether or not the pair (d, k) participates in a given instance of a concentration limit, while V_{d,k}^{(ζ,} [symbol] ⁾ may be a function of the rule [symbol] and attributes of d and k.

In an embodiment, to express a concentration limit constraint [symbol] that requires the weighted average of a quantity Q to not exceed a given limit Q̅, the constraint may be expressed as

$${\sum }_{Ϛ} {\sum }_{d ∈ 𝔻} {\sum }_{k ∈ 𝕂} {I}_{d , k}^{( Ϛ , ℛ )} {π}_{k} {N}_{d , k}^{( Ϛ )} \cdot ( 1 - {h}_{d , k} ) \cdot ( {Q}_{d , k} - \overline{Q} ) \leq 0 ,$$

which may be written in the form of the general concentration limit by setting V_{d,k}^{(ζ,} [symbol] ⁾=πₖ·(1−h_{d,k})·(Q_{d,k}− Q̅) and [symbol] =0.

Other concentration limit constraints may be implemented in some embodiments. For example, in an embodiment the total value allocated to a set of trades and collaterals may be constrained to not exceed a defined limit, such that

$${\sum }_{d ∈ 𝔻} {\sum }_{k ∈ 𝕂} {π}_{k} \cdot {N}_{d , k}^{( out )} \cdot {I}_{d , k}^{( {ℛ}_{v} )} \leq {\overline{V}}^{( {ℛ}_{v} )} ,$$

where I_{d,k}⁽ [symbol] ^{ᵥ}⁾ is an indicator function defined by an instance of a rule [symbol] ᵥ and V̅⁽ [symbol] ^{ᵥ}⁾ is the value of the limit. In an embodiment, the total par amount allocated to a set of trades and collaterals may be constrained to not exceed a defined limit, such that

$${\sum }_{d ∈ 𝔻} {\sum }_{k ∈ 𝕂} {N}_{d , k}^{( out )} \cdot {I}_{d , k}^{( {ℛ}_{n} )} \leq {\overline{N}}^{( {ℛ}_{n} )} ,$$

where I_{d,k}⁽ [symbol] ^{ₙ}⁾ is an indicator function defined by an instance of a rule [symbol] ₙ and N̅⁽ [symbol] ^{ₙ}⁾ is the par amount limit.

Given constraints in the optimization at 290, such as those described above, the optimization at 290 may be configured to further minimize cost and risk while maximizing yield. It may be appreciated that in some embodiments, users of the process 200, as implemented on various systems (e.g., collateral optimizer 180), may elect to select minimizing one or more attributes while holding one or more attributes fixed. In an embodiment, default selections may be provided by the financial services provider 100, may be modified by the client 110, or may otherwise be selected by a user of the collateral optimizer 180. In some embodiments, various minimizations may be applied in series, or may be applied in parallel.

With reference to the conventions and constraints described above, in an embodiment the optimization at 290 may include, for example, minimizing collateral shortfall:

$${\sum }_{d ∈ 𝔻} ( {V}_{d} - {A}_{d} ) \cdot θ ( {V}_{d} - {A}_{d} ) ,$$

where V_{d} is the value of the collateral for the trade d, and A_{d} is the haircut adjusted value of the collateral allocated to the trade d. In an embodiment, the optimization at 290 may include minimizing the overall weighted desirability:

$${\sum }_{d ∈ 𝔻 , k ∈ 𝕂} {ξ}_{k} \cdot {π}_{k} \cdot {N}_{d , k}^{( out )} ,$$

where (as noted above) represents the desirability of collateral k. In an embodiment, the optimization at 290 may include minimizing the overall weighted haircut:

$${\sum }_{d ∈ 𝔻 , k ∈ 𝕂} {h}_{d , k}^{( out )} \cdot {π}_{k} \cdot {N}_{d , k}^{( out )} .$$

In an embodiment, the optimization at 290 may include minimizing settlement and transaction costs:

$${\sum }_{d ∈ 𝔻 , k ∈ 𝕂} {v}_{d , k} \cdot {π}_{k} \cdot {N}_{d , k}^{( out )} ,$$

where v_{d,k}ε(0.1) is an index reflecting the settlement and transaction cost associated with collateral k in trade d. Other minimizations that may be implemented in the optimization at 290 include, for example, minimizing correlation with the trade that the collaterals are covering:

$${\sum }_{d ∈ 𝔻 , k ∈ 𝕂} {c}_{d , k} \cdot {π}_{k} \cdot {N}_{d , k}^{( out )} ,$$

where c_{d,k} is an index that reflects the correlation between the trade d and the collateral k, typically made proportional to the correlation coefficient between a portfolio presented by the allocated collaterals N_{d,k} and the assets underlying the trade.

Again, as noted above, in some embodiments two or more of the minimizations described herein may be linearly combined.

In an embodiment, the optimization at 290 may include minimizing the collateral preference index:

$$\frac{1}{V} {\sum }_{d ∈ 𝔻 , k ∈ 𝕂} {e}_{d , k} \cdot {π}_{k} \cdot {N}_{d , k}^{( out )} , where V = {\sum }_{d ∈ 𝔻} {V}_{d}$$

describes the total value of required collateral, and e_{d,k}=ξₖ+λₕ·h_{d,k}^{(out)}+λᵥ·v_{d,k}+λ_{c}c_{d,k}, where the λ coefficients are relative weights measured against that of desirability.

In some embodiments, the collateral optimization methods may be configurable by the clients 110, however defaults may be provided for the optimization configuration, so that the lowest-cost solution to fund the collateral of the client 110 may be readily identified. Other optimization parameters may additionally or alternatively be utilized, including optimizing based on legal entity, or optimizing based on exposure, risk, and/or credit parameters. In an embodiment, the optimization may associate certain collateral based on the type of contract/agreement that is the source of the collateralization obligation. For example, certain collateral may be tied to bilateral, trilateral, or quad party agreements, and thus the optimization may maintain that relationship. In other embodiments, the collateral may be reallocated across legal entities. As noted above, division of the collateral data may be by any of the views of collateral data as described with reference to the collateral aggregator 150 above (e.g., dividing by asset industry or sub industry, by cash, by security, by liquidity, and so on).

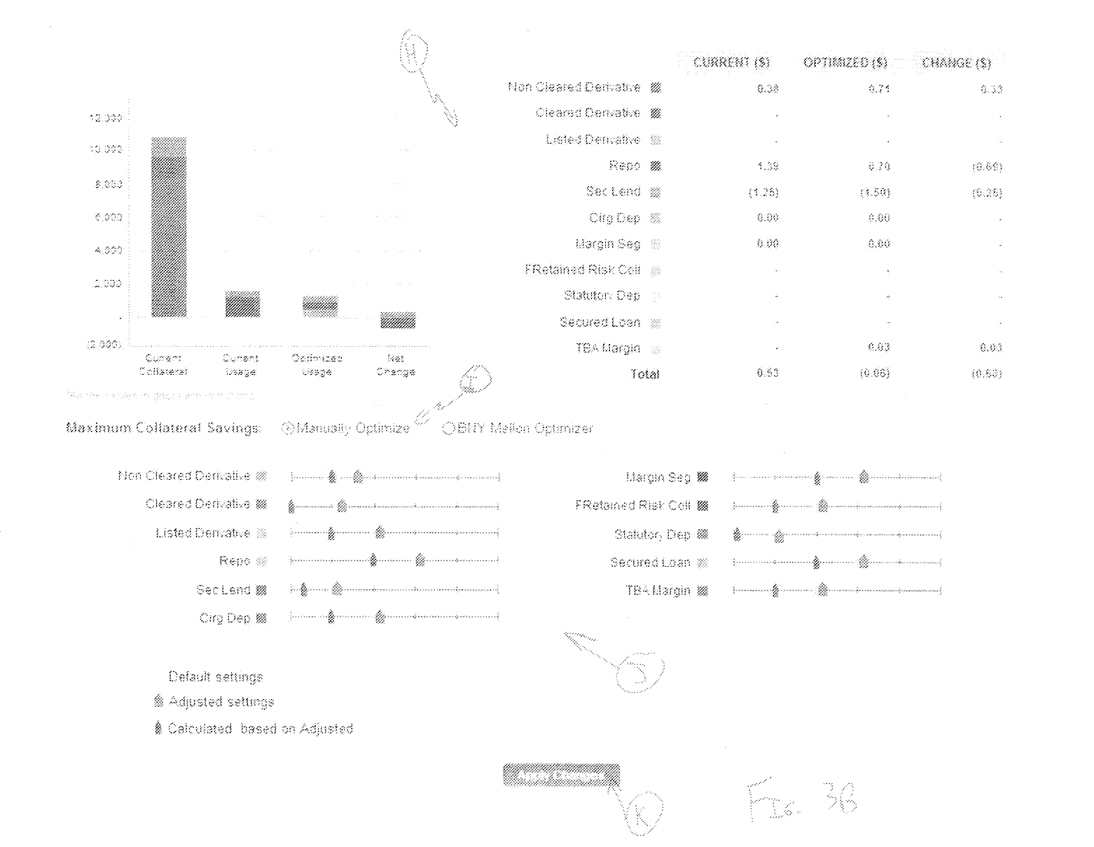

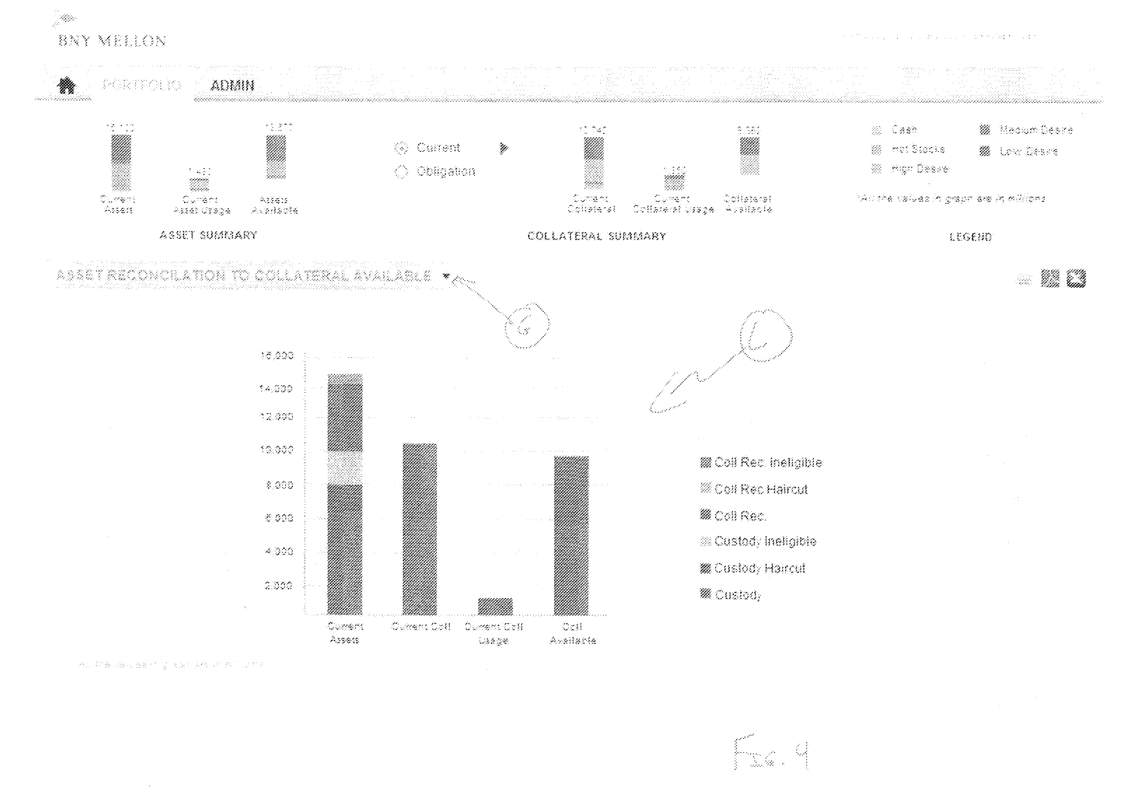

Although the interface to the systems described herein, or to implement methods described herein, may vary across embodiments, it may be appreciated that in an embodiment the financial service provider 100 may be configured to provide a graphical user interface accessible by one or more of users at the client 110 and users (or managers) at the financial service provider 100. In an embodiment, the interface may be accessible over the network 120, and may utilize a user login and password combination, or access may be tied to particular network addresses. FIGS. 3A-9B illustrate various exemplary views of a graphical user interface, providing both collateral allocation and optimization options, as well as administrative options. Specifically, FIGS. 3A-8 illustrate exemplary embodiments of portfolio views, while FIGS. 9A and 9B illustrate exemplary embodiments of administrative views. It may be appreciated that in an embodiment, a “Portfolio” link A may bring a user to the portfolio view, while an “Admin” link B may bring the user to the administrative view.

As shown in portfolio views of FIGS. 3A-8, in an embodiment the graphical user interface may show an Asset Summary section C, a collateral summary section D, and a legend section E. Each of the Asset Summary section C and the Collateral Summary section D may reflect aggregated values, subdivided as graphically represented based on the information in the Legend section E. In the illustrated embodiment, the current assets, current asset usage, and available assets are represented in the Asset Summary section C, while the current collateral, current collateral usage, and collateral available may be represented in the Collateral Summary section D. In an embodiment, the Collateral Summary section D may include a selector box F that may allow for user selection of current collateral summaries or obligated collateral summaries.

A sub-view selector G may be provided in the graphical user interface, and may facilitate selection of a variety of detailed views based on the aggregated data. For example, in FIG. 3A, the sub-view selected from selector G is of collateral activity. Accordingly, a Collateral Activity view H is depicted. In the illustrated embodiment, the Collateral Activity view H depicts current collateral activity over a variety of product types (e.g., from repurchase agreements, and from securities lending), showing the current usage in dollars, as well as the projected results of an optimized allocation. A resultant change from current allocations to optimized allocations is also presented. In an embodiment, the default view may be based on default settings, however a manual optimization may also be presented. In the illustrated embodiment of FIG. 3A, manual or default optimization may be selected by a selector I.

In an embodiment, selecting manual optimization at the selector I may present the Manual Settings view J, such as is illustrated in the view of FIG. 3B. In the illustrated embodiment, the Manual Settings view J may expand the view from FIG. 3A. As shown, in an embodiment the Manual Settings view J may depict a ranked weight slider for each of the variety of product types, and the projected results based on both the default settings and projected results based on the adjusted settings may be previewed. Once a desired weighting is selected, the manual optimization may be processed by selecting to apply the changes at K.

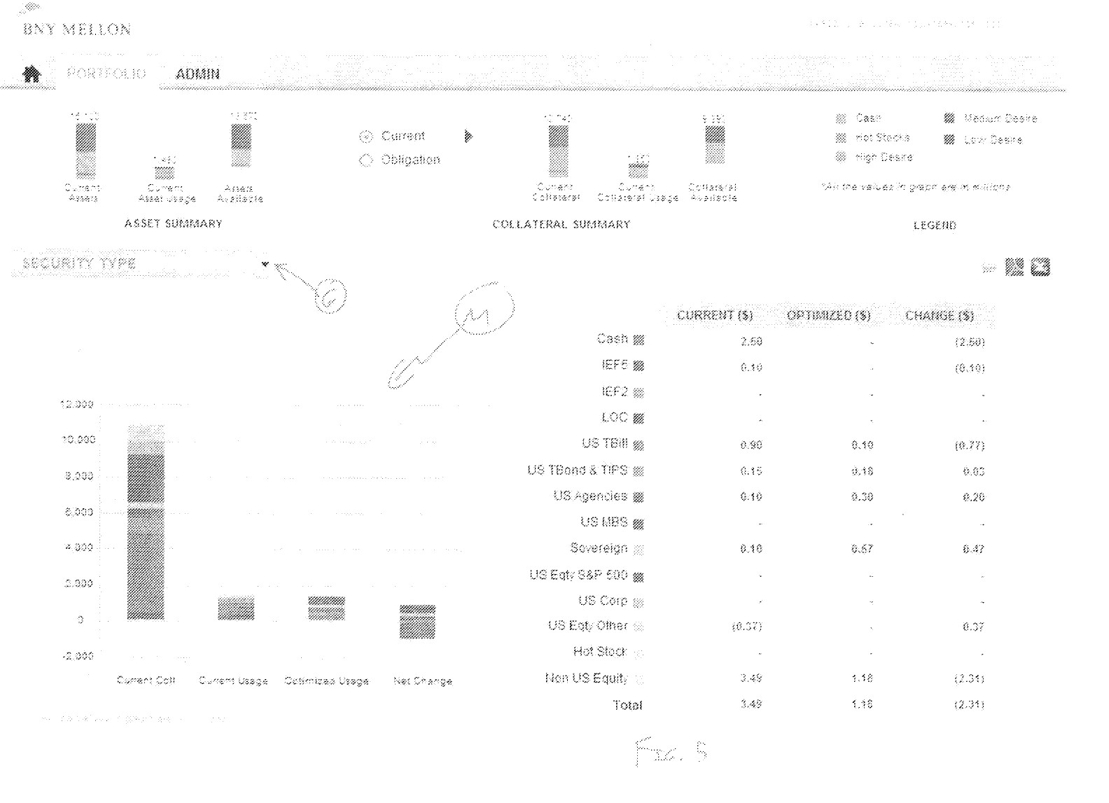

As shown in FIG. 4, selecting at G to view asset reconciliation to collateral available may depict an Asset Reconciliation view L, which may show in greater detail the current assets as compared to the current collateral, the current collateral usage, and the collateral available. In some embodiments, such as that illustrated, the amount of each associated with ineligible collateral and custody, and the haircut on the collateral and custody, may be graphically depicted.

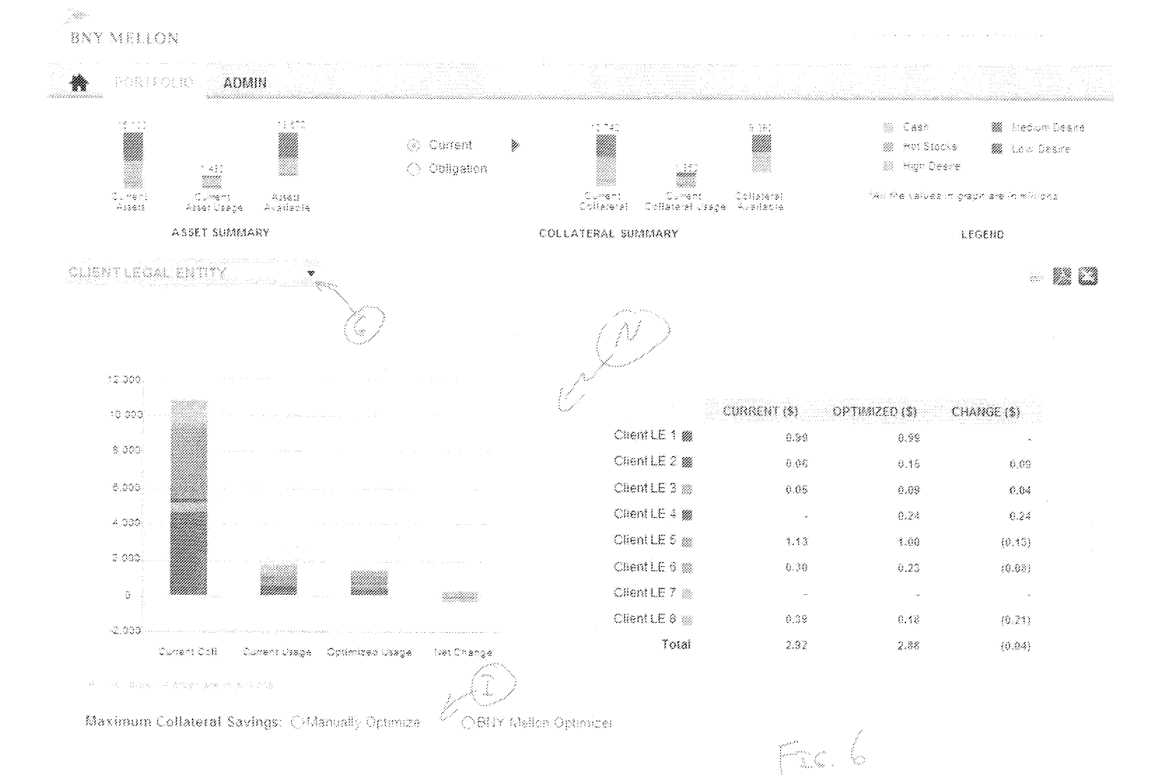

FIG. 5 depicts that, in an embodiment, selecting to view security types at G may depict a Security Type view M, which may show in greater detail the current collateral, the current collateral usage, an optimized usage, and a net change, across a variety of security types. In the illustrated embodiment, a variety of security types are depicted, including cash, U.S. T-bills, a several types of equities, and others. In an embodiment, the current amount of collateral associated with each security type, an optimized amount, and the resultant change, are each listed. Although not depicted in FIG. 5, it may be appreciated that in an embodiment the ability to select manual optimization at I may be provided on each view selected at G.

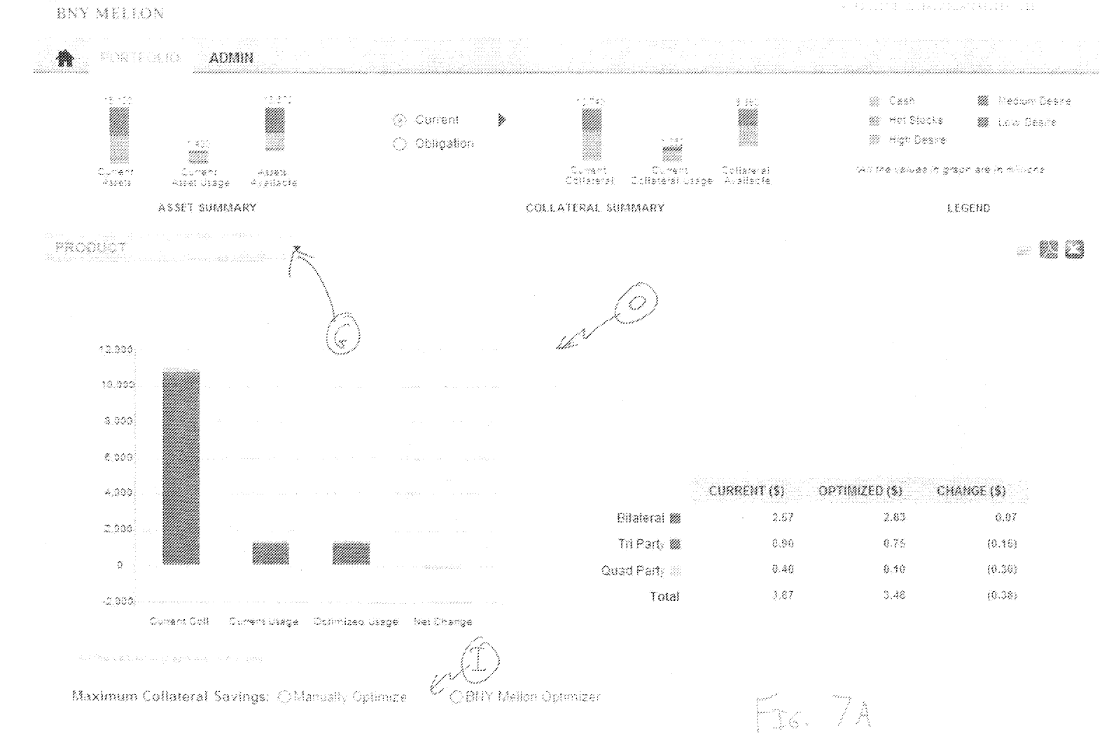

As illustrated in FIG. 6, in an embodiment, selecting to view client legal entity at G collateral available may depict a Legal Entity view N, which may show the collateral amounts subdivided by client legal entity. In an embodiment, the current amount of collateral associated with each security type, an optimized amount, and the resultant change, are each listed. As shown, the manual optimization may be implemented at I in some embodiments.

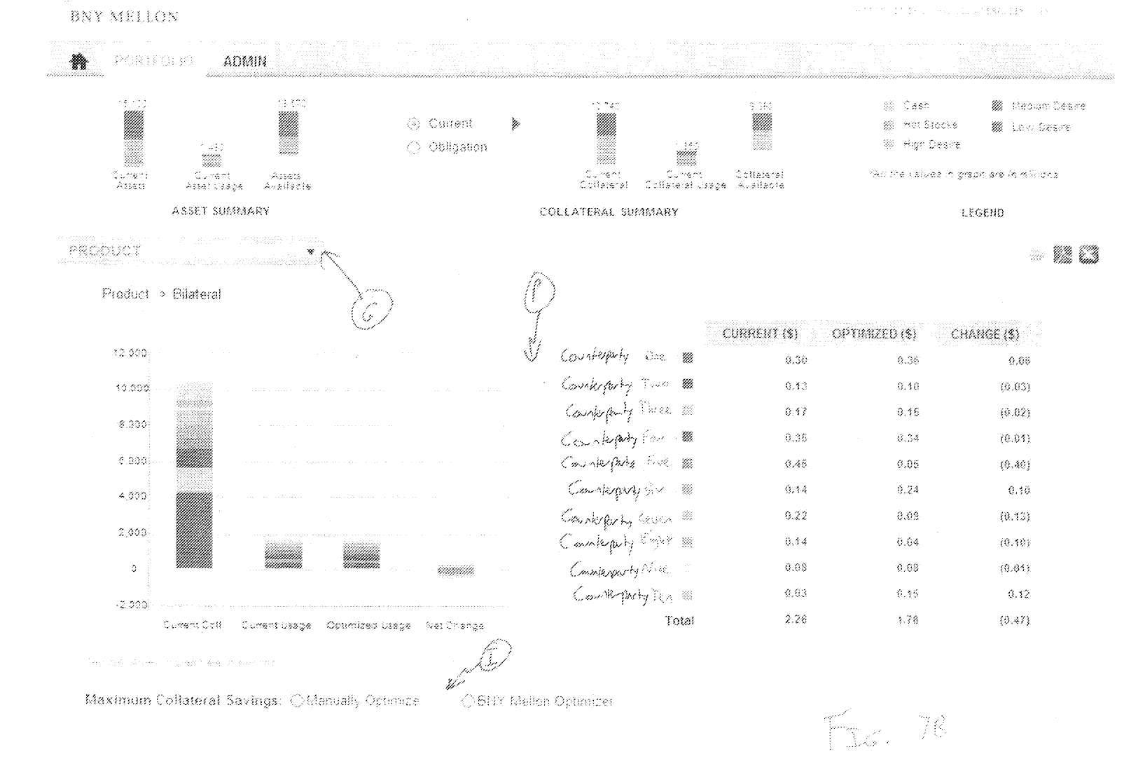

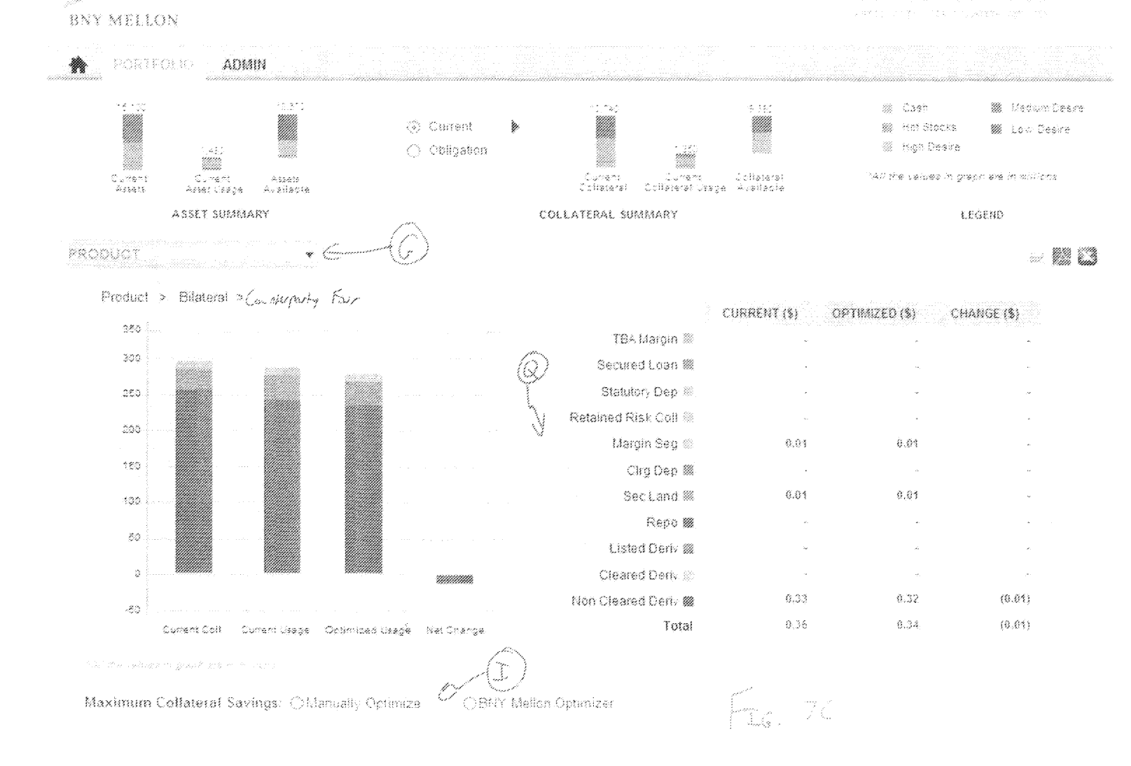

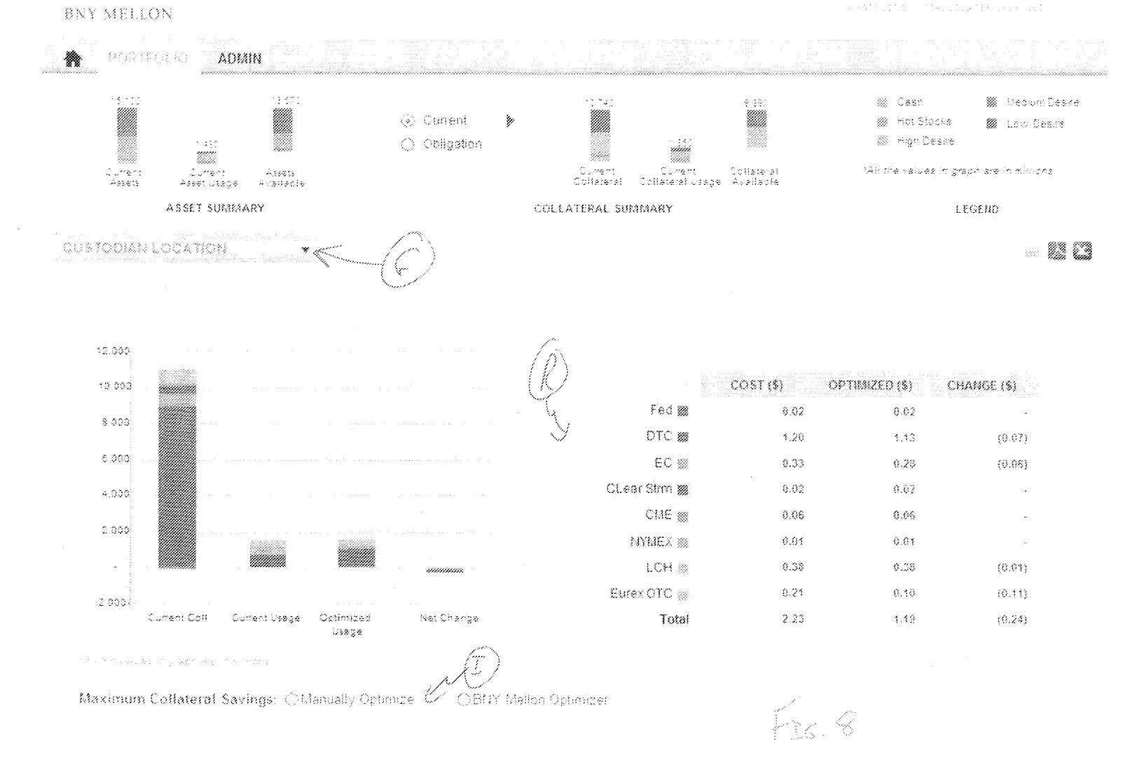

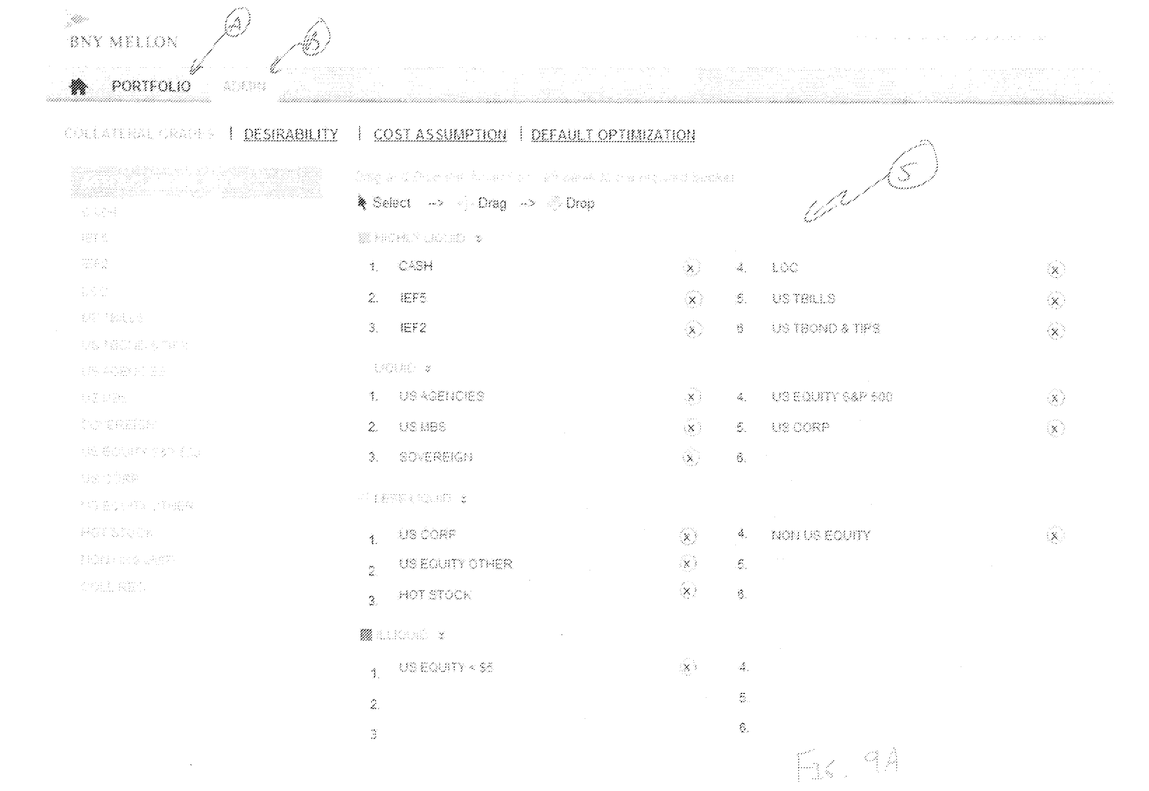

FIGS. 7A-7C depict Product views O, P, and Q, showing in successively greater detail collateral allocations by product type. Specifically, in the illustrated embodiment, by selecting product at G, the graphical user interface may display the view O, showing collateral aggregations for each of bilateral, tri party, and quad party product type categories. As additionally shown, the current collateral and current usage, as well as a projected optimized usage and net change, may be broken down by the product type categories. The current cost, optimized cost, and change in cost may be displayed for each product type category. Optimizing automatically, or by manual control over weight to the selected product type categories may in some embodiments be selected at I. In an embodiment, by selecting one of the product types, the view P of FIG. 7B may be shown, displaying collateral allocations for different counterparties within that product type. As shown, the breakdown of current collateral, current usage, optimized usage, and net change within that product type may be illustrated, and the current cost, optimized cost, and change in cost may be listed for each of the counterparties collateral, as well as in the aggregate. Again, selecting between a default optimizer and manually weighting the optimization may be selected at I in some embodiments. As shown in FIG. 7C, by selecting one of the counterparties in view P, the specific product types within the category for that counterparty may be listed, and the current collateral, current usage, optimized usage, and net change may be illustrated. For example, in the illustrated embodiment, the graphical user interface depicts the cost impact and prevalence for each of a variety of product types, such as non-cleared derivatives, associated with a particular counterparty. Once more, in an embodiment, selecting between a default optimizer and manually weighting the optimization may be selected at I.

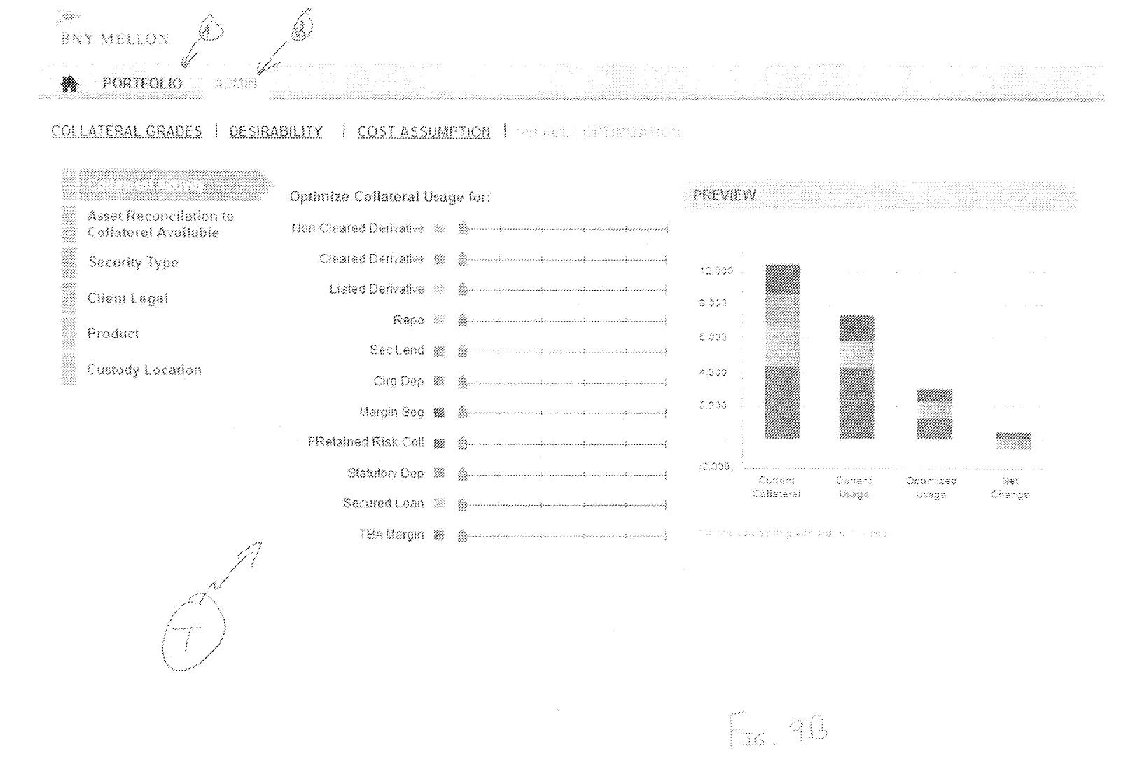

As shown in FIG. 8, in an embodiment custodian location may be selected at G, which may cause the graphical user interface to display a Custodian Location view R. As shown in the Custodian location view R, the current collateral, current usage, optimized usage, and a net change may be illustrated for collateral associated with each of a plurality of custodians, including but not limited to FED, DTC, and CME, for example. In an embodiment, the current cost, optimized cost, and change as a result of the optimization may be listed for each of the custodians, as well as in the aggregate. As shown at I, default or manual optimization may again be selected in some embodiments of this view.

As noted above, in some embodiments administrative tools may be viewed, such as by selecting the Admin link B. As shown in FIG. 9A, in an embodiment the user may administer collateral grades on a Collateral Grade view S, by associating various asset classifications as being a certain grade of liquidy. Specifically, in the illustrated embodiment, the user may designate various asset classifications as being highly liquid, liquid, less liquid, or illiquid. While the illustrated grading is for liquidity, it may be appreciated that other collateral grading schemes, such as those described above, may additionally or alternatively be administered. FIG. 9A further shows that in an embodiment, desirability, cost assumption, and default optimizations may additionally be administered. FIG. 9B illustrates an example of a Default Optimization view T, wherein default optimizations may be set for each of the various views selectable at G (e.g., collateral activity, asset reconciliation to collateral available, security type, client legal entity, product, and custody location). As shown, a preview of the current collateral, current usage, optimized usage, and net change based on the selectable optimization settings may be provided in the Default Optimization view T in some embodiments.

Those skilled in the art will appreciate that the embodiments described herein can be implemented using a server, computer, database, communications and programming technology, each of which implements hardware or software or any combination thereof. Embodiments of this disclosure may be implemented in the form of a computer program product on a computer-readable storage medium having computer-readable program code means embodied in any suitable computer-readable storage medium, including hard disks, CD-ROM, RAM, ROM, optical storage devices, magnetic storage devices, and/or the like.

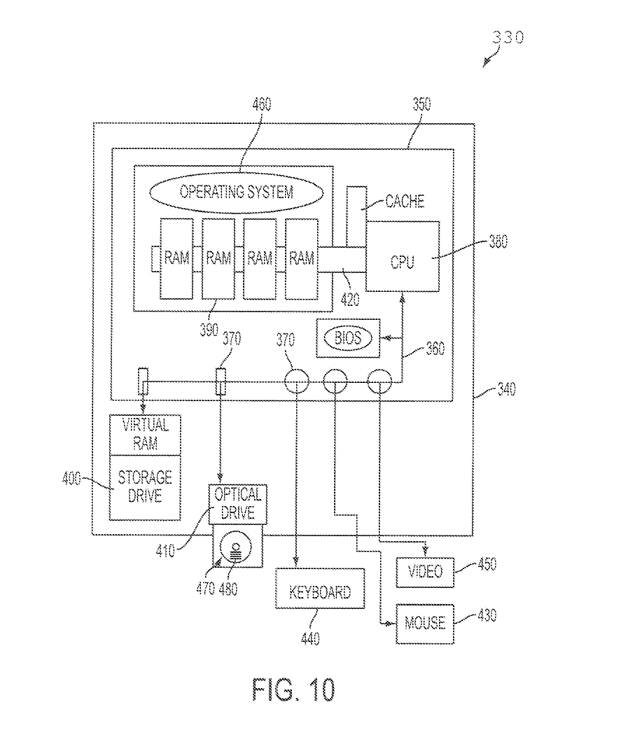

For example, FIG. 10 illustrates a high level block diagram of an exemplary computer system 330 which may be used to perform embodiments of the processes disclosed herein, including but not limited to process 200. It may be appreciated that in some embodiments, the system performing the processes herein may include some or all of the computer system 330. In some embodiments, the computer system 330 may be linked to or otherwise associated with other computer systems 330. In an embodiment the computer system 330 has a case 340, enclosing a main board 350. The main board has a system bus 360, connection ports 370, a processing unit, such as Central Processing Unit (CPU) 380, and a data storage device, such as main memory 390, storage drive 400, and optical drive 410. Each of main memory 390, storage drive 400, and optical drive 410 may be of any appropriate construction or configuration. For example, in some embodiments storage drive 400 may comprise a spinning hard disk drive, or may comprise a solid-state drive. Additionally, optical drive 410 may comprise a CD drive, a DVD drive, a Blu-ray drive, or any other appropriate optical medium.

Memory bus 420 couples main memory 390 to CPU 380. A system bus 460 couples storage drive 400, optical drive 410, and connection ports 370 to CPU 380. Multiple input devices may be provided, such as for example a mouse 430 and keyboard 440. Multiple output devices may also be provided, such as for example a video monitor 450 and a printer (not shown). In an embodiment, such output devices may be configured to display information regarding the processes disclosed herein, including but not limited to cash amounts, trade details, and so on. It may be appreciated that the input devices and output devices may alternatively be local to the case 340 and the computer system 330, or may be located remotely (e.g., interfacing with the computer system 330 through a network or other remote connection).

Computer system 330 may be a commercially available system, or may be proprietary design. In some embodiments, the computer system 330 may be a desktop workstation unit, and may be provided by any appropriate computer system provider. In some embodiments, computer system 330 comprise a networked computer system, wherein memory storage components such as storage drive 400, additional CPUs 380 and output devices such as printers are provided by physically separate computer systems commonly tied together in the network. Those skilled in the art will understand and appreciate the physical composition of components and component interconnections comprising computer system 330, and select a computer system 330 suitable for performing the methods disclosed herein.

When computer system 330 is activated, preferably an operating system 460 will load into main memory 390 as part of the boot sequence, and ready the computer system 330 for operation. At the simplest level, and in the most general sense, the tasks of an operating system fall into specific categories—process management, device management (including application and user interface management) and memory management.

In such a computer system 330, the CPU 380 is operable to perform one or more embodiments of the methods described above. Those skilled in the art will understand that a computer-readable medium 470 on which is a computer program 480 for performing the methods disclosed herein may be provided to the computer system 330. The form of the medium 470 and language of the program 480 are understood to be appropriate for computer system 330. Utilizing the memory stores, such as one or more storage drives 400 and main system memory 390, the operable CPU 380 will read the instructions provided by the computer program 480 and operate to perform the methods disclosed herein, such as process 300.

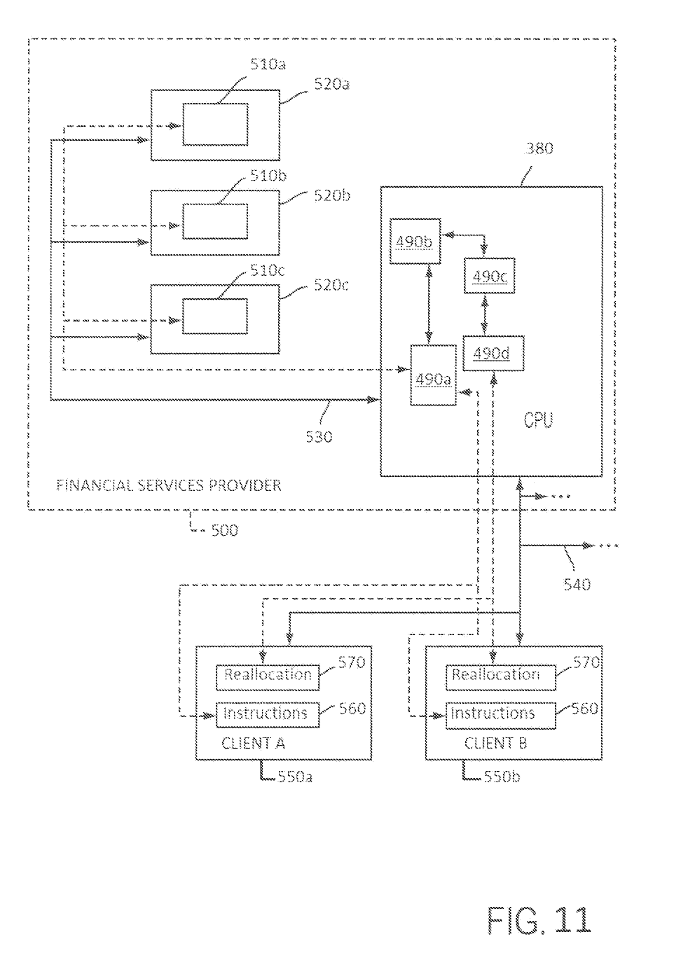

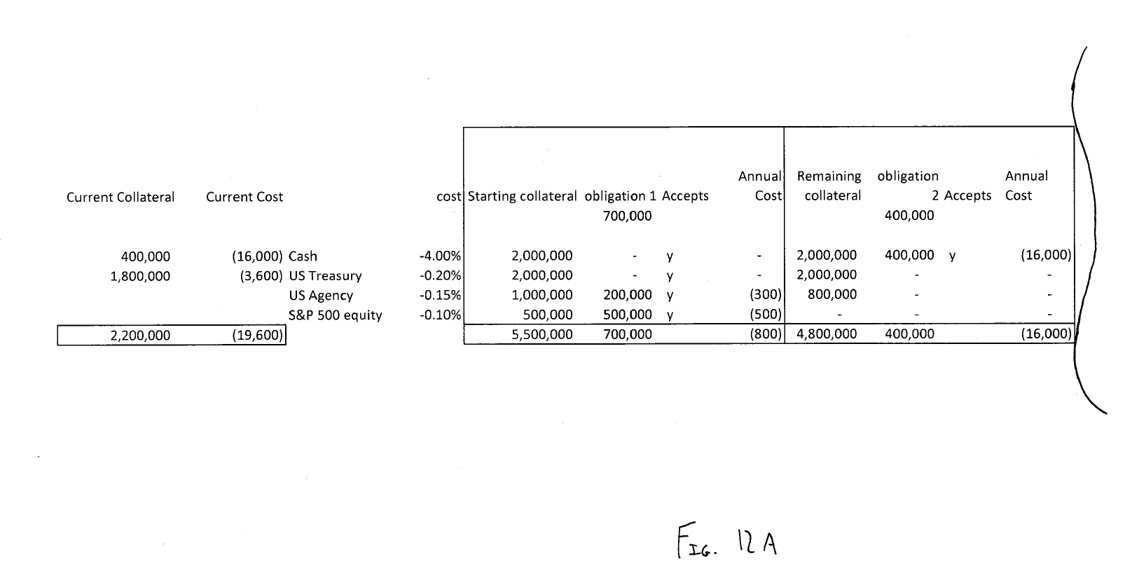

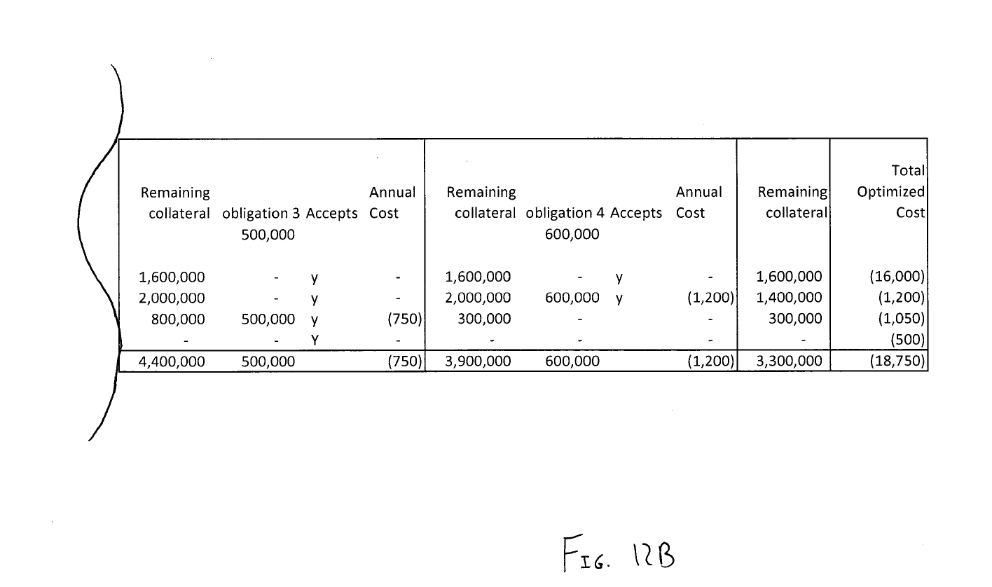

As shown in FIG. 11, in some embodiments the CPU 380 (either alone or in conjunction with additional CPUs 380) may be configured to execute one or more computer program modules 490, each configured to perform one or more functions of the processes described herein. For example, in the illustrated embodiment, at a CPU 380 operated by a financial service provider 500, a computer program module 490a may be configured to aggregate collateral data 510 from each of a plurality of financial subsystems 520 of the financial services provider 500. In the illustrated embodiment, there are three financial subsystems (520a-c) depicted, each having its own associated collateral data 510a-c. In various embodiments, the financial subsystem 520 may be similar to the financial subsystems 130 described above, and likewise the collateral data 510 may be similar to the data describing the collateral 140 as discussed above. In an embodiment, the collateral data 510 may be associated with one or more storage drives 400, accessible by the CPU 380 directly or indirectly (e.g., via the system bus 360, or via a network 530, such as is illustrated). Accordingly, in an embodiment each of the financial subsystems 520 may comprise their own CPUs and storage systems. In an embodiment, the network 530 may be an internal network between the CPU 380 running the computer program modules 490. In an embodiment, the network 530 may link to a network 540 coupling the financial services provider 500 to one or more clients 550. In the illustrated embodiment, there are two clients 550a and 550b depicted.

In an embodiment, the collateral data 510 from the financial subsystems 520 may be aggregated as aggregated collateral data which may be manipulated by the computer program module 490a. For example, the computer program module 490a may be configured to access and manipulate, on electronic storage media such as the storage drive 400, collateral information for collateral accounts associated with the clients 550 on each of the financial subsystems 520. In an embodiment, the aggregated collateral data may be similar to that described above as aggregated collateral information 160. As shown, in an embodiment each of the clients 550 may be able to manipulate or filter results of the aggregation by the computer program module 490a, such as by providing instructions 560 to the computer program module 490a, or other computer program modules 490 associated with the financial services provider 500. In an embodiment, default instructions may be proposed to the clients 550, and may be based on the aggregated collateral data, as described above. In an embodiment, the computer program module 490a may be configured to receive the instructions 560 from the clients 550 via a graphical user interface, such as that described above.

In an embodiment, a computer program module 490b may calculate a cost associated with a utilized amount of the collateral described in the aggregated collateral data, across each of a plurality of categories described in the aggregated collateral data. Such calculation may comprise manipulation of the data adapter 170 described above, or a similar mechanism. In an embodiment, the computer program module 490b may be linked with the computer program module 490a, may be a part of the computer program module 490a, or may otherwise be associated with the computer program modules 490 on one or more of the CPUs 380.

In an embodiment, a computer program module 490c may be configured to calculate an optimized cost based on a reallocation of the collateral. In an embodiment, the optimized cost may be based on reallocating the collateral to minimize the cost associated with the utilized amount of the reallocated collateral. In an embodiment, it may be appreciated that calculating the optimized cost may test reallocations in a theoretical sense, without actually reallocating collateral until approved by the clients 550. As described herein, the cost of collateral may be defined by the user at a security or asset type level. In an embodiment, default collateral costs may be provided to the client 110, and may be utilized if the client 110 does not enter their own overriding cost assumptions. In an embodiment, basis point earnings on revenue generating stocks or other securities may be sourced from securities lending systems at a security level. It may be appreciated that potential collateral positions may be compared against the potential revenue generating stocks, to identify which revenue opportunities should be held back from collateral allocations.

It may be appreciated that in an embodiment, a computer program module 490d may be configured to transmit, for viewing on an electronic display communicatively linked with the one or more processors, the optimized cost based on the proposed reallocation (e.g., as part of a proposed reallocation 570). In an embodiment, the transmitted output may be configured for display over a graphical user interface, which may be the same graphical user interface (such as that described above) which facilitates transmission of the instructions 560 between the clients 550 and the financial services provider 500. In an embodiment, the client 550 may selectively request implementation of the proposed reallocation 570, such as by indicating such via the graphical user interface over the network 540.

While in FIG. 11 each of the program modules 490 are shown as linked in serial, it may be appreciated that the program modules 490 may each be linked with each other, on the same CPU 380, or across a plurality of CPUs 380. In effect, in an embodiment, a plurality of modules 490, operating over one or more CPUs 380, may cooperate with one another to perform the methods described herein.

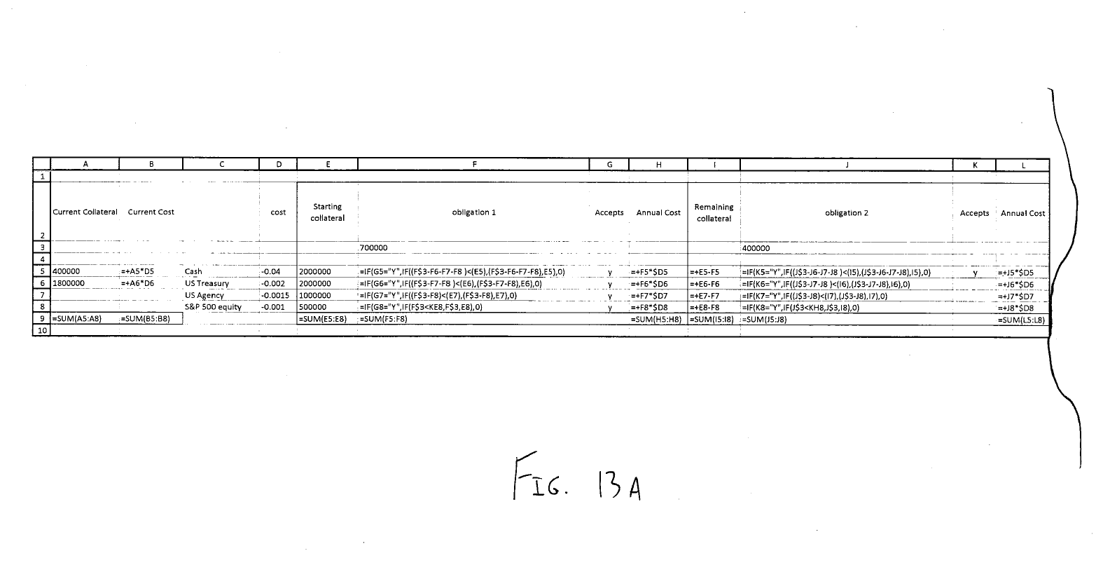

FIGS. 12A-B illustrate by way of example an optimization procedure, illustrating how a current collateral allocation may be reallocated. As shown in the example, various asset types may have costs associated with them. The costs may be understood as opportunity costs, which may be measured in basis points or a percentage detriment associated with their use. For example, Cash may have a high cost associated therewith, while Equities may have a relatively low cost associated therewith. Such costs may be based on the ubiquitous ability to utilize certain asset types over others. In the example of FIGS. 12A-B, Cash has a cost of −4.00%, while US Treasuries has a cost of −0.20%, US Agencies (securities) have a cost of −0.15%, and S&P 500 Equities have cost of −0.10%. As currently allocated, a party may be utilizing $400,000 in cash, and $1,800,000 in U.S. Treasuries, totaling $2,200,000. Factoring in the dollar amount of the each type of collateral, and the asset type cost associated therewith, it may be understood that the cost of utilizing $400,000 in cash is $16,000 (−4.00%*400,000), while the cost of utilizing $1,800,000 in US Treasuries is $3,600 (−0.20%*$1,800,000). Accordingly, the total current cost of the utilized asset types is $19,600. In an embodiment, the costs associated with each asset type may be received from users (e.g., the clients 110), or may be provided or suggested by the financial service provider 100.

As further shown in the simplified example in FIGS. 12A-B, there may be four obligations which the collateral should satisfy. Obligation 1 being $700,000, Obligation 2 being $400,000, Obligation 3 being $500,000, and Obligation 4 being $600,000. It may be appreciated that the sum of each obligation totals the $2,200,000 of current collateral. As shown, in an embodiment the optimization may first seek to satisfy the obligation utilizing the lowest cost collateral that it is eligible to use. For example, if the party initially has $2,000,000 of cash, $2,000,000 of US Treasuries, $1,000,000 of US Agencies, and $500,000 of S&P 500 Equities, the optimization may seek to first use the maximum amount of S&P 500 Equities, as they will have the lowest cost. As such, because Obligation 1 accepts S&P 500 Equities, the optimization may exhaust its supply of the low cost equities in Obligation 1. Because the exhausted amount of S&P 500 Equities is less than the total obligation, the optimization may continue with the next lowest cost asset type, US Agencies. To fill the $700,000 amount of Obligation 1, having utilized $500,000 in US Equities, the optimization would then utilize $200,000 of US Agencies. As shown, in an embodiment the cost of utilizing each asset type per obligation may be computed as well, and summed (e.g., totaling $800 in cost for Obligation 1).

The remaining collateral may be computed (e.g., by subtracting the utilized collateral for each collateral type), and the process may repeat for Obligation 2. As shown, Obligation 2 only accepts Cash as collateral. Thus, while US Agencies remain, they cannot be utilized to satisfy Obligation 2. Accordingly, the full amount of Obligation 2 may be satisfied through the necessary cash, and an associated cost of $16,000 is computed. The process may again proceed with Obligation 3, which by accepting all asset types, may be fulfilled by the lowest cost asset type, US Agencies. Finally, Obligation 4 may be satisfied, again determining first if the asset type is eligible for satisfying the obligation, and then by utilizing the lowest cost eligible asset type.

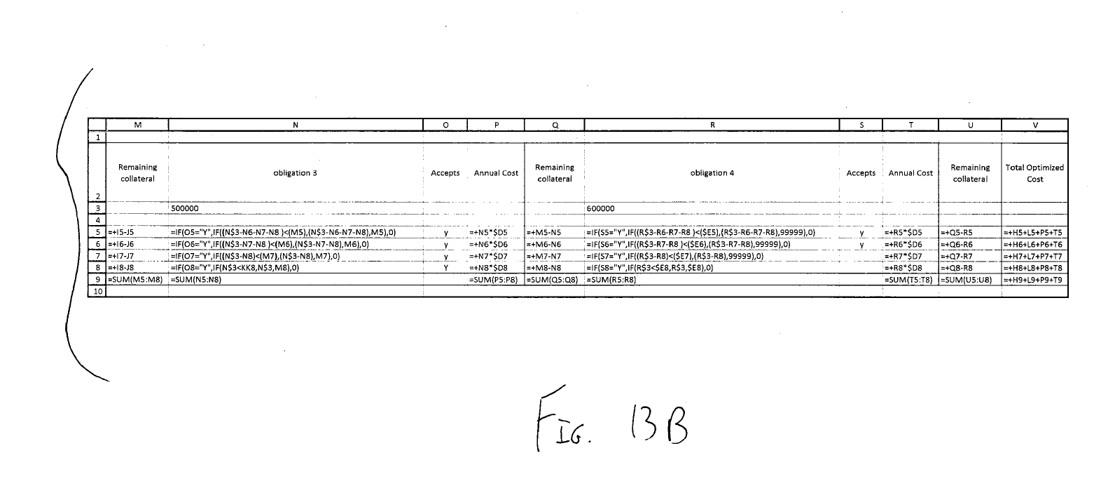

Accordingly, as a result of the optimization, what was originally being satisfied by $400,000 in cash and $1,800,000 in US Treasuries, with a total opportunity cost of $19,600 associated therewith, would be satisfied by $500,000 in S&P 500 Equities, $700,000 in US Agencies, $600,000 in US Treasuries, and $400,000 in Cash. It may be computed from the costs associated with each of these asset types that the opportunity cost of satisfying the Obligations is reduced to $18,750, and that a large amount of US Treasuries that would otherwise be inefficiently utilized may be freed up as a product of the optimization. To illustrate how the computations in the example of FIGS. 12A and 12B are produced, FIGS. 13A and 13B show the formulas utilized to compute the amount to be utilized from each asset type if possible.

Although not depicted in the illustrated example, it may be appreciated that in some embodiments concentration requirements may be implemented in the optimization, such as where one of the counterparties wants to cap a percentage of an asset type utilized to satisfy an obligation. Accordingly, other considerations may additionally or alternatively be implemented in the optimization, and the illustrated embodiment is not intended to be limiting in any way.

The above-discussed embodiments and aspects of this disclosure are not intended to be limiting, but have been shown and described for the purposes of illustrating the functional and structural principles of the inventive concept, and are intended to encompass various modifications that would be within the spirit and scope of the following claims.

Various embodiments may be described herein as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to this disclosure without departing from the scope or spirit of the inventive concept described herein. As such, the specification and drawings should be regarded as examples only, and the scope of the inventive concept to be determined solely by the appended claims.

What is claimed is:

1. A system for managing collateral of a client of a financial services provider, the system comprising one or more processors configured to execute one or more computer program modules, the program modules being configured to:
aggregate collateral data from a plurality of financial subsystems of the financial services provider as aggregated collateral data, the aggregated collateral data being associated with collateral across the plurality of financial subsystems;
calculate a cost associated with each of the collateral, across each of a plurality of categories described in the aggregated collateral data;
calculate an optimized cost based on a proposed reallocation of the collateral, the optimized cost being associated with a utilized amount of reallocated collateral; and
transmit, for viewing on an electronic display communicatively linked with the one or more processors, the optimized cost based on the proposed reallocation.

2. The system of claim 1, wherein the program modules are further configured to generate allocation instructions to implement the reallocation associated with the optimized cost.

3. The system of claim 2, wherein the allocation instructions are configured to be implemented by the financial services provider.

4. The system of claim 1, wherein the cost associated with the utilized amount of the collateral is calculated based on a desirability factor based on asset types.

5. The system of claim 4, wherein the desirability factor is received from the client or is provided by the financial services provider.

6. The system of claim 1, wherein the cost associated with the utilized amount of the collateral is calculated as an annualized dollar amount.

7. The system of claim 1, wherein the plurality of financial subsystems comprise one or more of a custody subsystem, a cash subsystem, a repurchase agreement subsystem, a derivatives subsystem, a liquidity subsystem, and a securities lending subsystem.

8. The system of claim 1, wherein the program modules are further configured to receive aggregation instructions from a user of the system, the aggregation instructions instructing the program modules on how to aggregate the collateral data.

9. The system of claim 8, wherein the user of the system is at the client.

10. The system of claim 1, wherein the plurality of categories comprise collateral characteristics including one or more of cleared, non-cleared, listed, repurchased, security lending, secured, associated counterparty, custodian location, and security type.

11. The system of claim 1, wherein calculating the optimized cost based on the proposed reallocation comprises verifying eligibility of potential collateral.

12. The system of claim 1, wherein calculating the optimized cost based on the proposed reallocation comprises selecting proposed collateral for each of a plurality of obligations, wherein the proposed collateral is selected from the collateral as one or more of the collateral having the smallest cost associated with the collateral.

13. The system of claim 1, wherein the plurality of categories described in the aggregated collateral data comprise an asset type.

14. The system of claim 13, wherein the asset type comprises cash, treasuries, securities, equities, stocks, or bonds.

15. The system of claim 1, wherein calculating the optimized cost based on the proposed reallocation comprises minimizing a sum of the costs associated with the utilized amount of reallocated collateral.

16. A computer implemented method for managing collateral of a client of a financial services provider, wherein the method is implemented in a computer system comprising one or more processors configured to execute one or more computer program modules, the method comprising:
aggregating, via the one or more processors, collateral data from a plurality of financial subsystems of the financial services provider as aggregated collateral data, the aggregated collateral data being associated with collateral utilized across the plurality of financial subsystems;
calculating, with the one or more processors, a cost associated with each of the collateral, across each of a plurality of categories described in the aggregated collateral data;
calculating, with the one or more processors, an optimized cost based on a proposed reallocation of the collateral being associated with a utilized amount of reallocated collateral; and
transmitting, for viewing on an electronic display communicatively linked with the one or more processors, the optimized cost based on the proposed reallocation.

17. The method of claim 16, further comprising generating, with the one or more processors, allocation instructions to implement the reallocation associated with the optimized cost.

18. The method of claim 17, wherein the allocation instructions are configured to be implemented by the financial services provider.

19. The method of claim 16, wherein the cost associated with the utilized amount of the collateral is calculated based on a desirability factor based on asset types.

20. The method of claim 19 wherein the desirability factor is received from the client or is provided by the financial services provider.

21. The method of claim 16, wherein the cost associated with the utilized amount of the collateral is calculated as an annualized dollar amount.

22. The method of claim 16, wherein the plurality of financial subsystems comprise one or more of a custody subsystem, a cash subsystem, a repurchase agreement subsystem, a derivatives subsystem, a liquidity subsystem, and a securities lending subsystem.

23. The method of claim 16, further comprising receiving, via the one or more processors, aggregation instructions from a user of the system, the aggregation instructions instructing the program modules on how to aggregate the collateral data.

24. The method of claim 23, wherein the user of the system is at the client.

25. The method of claim 16, wherein the plurality of categories comprise collateral characteristics including one or more of cleared, non-cleared, listed, repurchased, security lending, secured, associated counterparty, custodian location, and security type.

26. The method of claim 16, wherein calculating the optimized cost based on the proposed reallocation comprises verifying eligibility of potential collateral.

27. The method of claim 16, wherein calculating the optimized cost based on the proposed reallocation comprises selecting proposed collateral for each of a plurality of obligations, wherein the proposed collateral is selected from the collateral as one or more of the collateral having the smallest cost associated with the collateral.

28. The method of claim 16, wherein the plurality of categories described in the aggregated collateral data comprise an asset type.

29. The method of claim 28, wherein the asset type comprises cash, treasuries, securities, equities, stocks, or bonds.

30. The method of claim 16, wherein calculating the optimized cost based on the proposed reallocation comprises minimizing a sum of the costs associated with the utilized amount of reallocated collateral.
